(19) United States
(12) Patent Application Publication
(10) Pub. No.: US 2018/0367514 A1
(43) Pub. Date: Dec. 20, 2018

(54) MOBILE-RELATED COMMUNICATION SYSTEM

(71) Applicant: Panasonic Intellectual Property Management Co., Ltd., Osaka (JP)

(72) Inventors: Shojiro KIDO, Osaka (JP); Toshiya MORIWAKI, Osaka (JP)

(21) Appl. No.: 16/004,406

(22) Filed: Jun. 10, 2018

(30) Foreign Application Priority Data
Jun. 15, 2017 (JP) 2017-117834

(51) Int. Cl. H04L 29/06; G07C 5/00; H04B 10/116; H04W 12/04; H04L 9/08

(52) U.S. Cl. CPC H04L 63/0435; G07C 5/008; H04B 10/116; H04L 2209/84; H04L 9/0819; H04L 2209/80; H04W 12/04

(57) ABSTRACT

A mobile-related communication system includes a first information transmitting body including a first wireless communication unit, a first control unit, and a first optical communication unit, and a second information transmitting body including a second wireless communication unit, a second control unit, and a second optical communication unit. The first control unit causes the first optical communication unit to acquire ID information of the second information transmitting body and an encryption key via the second optical communication unit and causes the first wireless communication unit to wirelessly transmit to the second information transmitting body a provision request for transmitting body-related information related to the second information transmitting body. The second control unit causes the encrypted transmitting body-related information using the encryption key to be wirelessly transmitted on the basis of the provision request, and the first control unit decrypts the received transmitting body-related information using the encryption key.

### INCORPORATION BY REFERENCE

The disclosure of Japanese Patent Application No. 2017-117834 filed on Jun. 15, 2017, including the specification, claims, drawings, and abstract, is incorporated herein by reference in its entirety.

### BACKGROUND

### Technical Field

The present disclosure relates to a mobile-related communication system.

### Related Art

In the past, a vehicle communication system that transfers vehicle information to other devices such as mobile terminals by means of optical communication has been proposed. For example, Japanese Unexamined Patent Application Publication No. 2010-241311 discloses a configuration capable of modulating light of a headlight with identification information of a vehicle identifying the vehicle and diagnosis information and extracting the vehicle identification information and the diagnosis information. Accordingly, in the technique disclosed in Japanese Unexamined Patent Application Publication No. 2010-241311, it is possible to specify the vehicle using identification information specific to the vehicle and facilitate an investigation into the cause of a failure or a malfunction.

However, it is desirable to suppress leakage of information to an unrelated third party when wireless communication of information is performed between two information transmitting bodies while increasing an application range of optical communication by performing optical communication between two information transmitting bodies. The technique disclosed in Japanese Unexamined Patent Application Publication No. 2010-241311 merely relates to extracting specific identification information and failure diagnosis information from a specific vehicle, for example, at factories and does not disclose a means for solving such a problem.

### SUMMARY

A mobile-related communication system which is an aspect of the present disclosure includes a first information transmitting body and a second information transmitting body that is able to perform wireless communication with the first information transmitting body, wherein at least one of the first information transmitting body and the second information transmitting body is a mobile body, the first information transmitting body includes a first wireless communication unit, a first control unit connected to the first wireless communication unit, and a first optical communication unit connected to the first control unit, the second information transmitting body includes a second wireless communication unit that performs wireless communication with the first wireless communication unit, a second control unit connected to the second wireless communication unit, and a second optical communication unit that is connected to the second control unit and performs optical communication with the first optical communication unit, (1) the first control unit causes the first optical communication unit to acquire ID information of the second information transmitting body and an encryption key via the second optical communication unit and causes the first wireless communication unit to wirelessly transmit a provision request for transmitting body-related information related to the second information transmitting body to the second information transmitting body, (2) the second control unit causes the transmitting body-related information encrypted with the encryption key to be wirelessly transmitted from the second wireless communication unit to the first wireless communication unit on the basis of the provision request for the transmitting body-related information, and (3) the first control unit decrypts the transmitting body-related information received by the first wireless communication unit using the encryption key and acquires the transmitting body-related information.

According to a mobile-related communication system which is an aspect of the present disclosure, it is possible to suppress leakage of information to an unrelated third party when wireless communication of information is performed between two information transmitting bodies while increasing an application range of optical communication.

### BRIEF DESCRIPTION OF THE DRAWINGS

The figures depict one or more implementations in accordance with the present teachings, by way of example only, not by way of limitations. In the figures, like reference numerals refer to the same or similar elements.

FIG. 1 is a diagram illustrating a traveling state of a first vehicle serving as a first mobile body and a second vehicle serving as a second mobile body to which a first mobile-related communication system according to an embodiment is applied;

FIG. 2 is a block diagram illustrating basic configuration of the first vehicle and the second vehicle illustrated in FIG. 1;

FIG. 3 is a diagram illustrating a second vehicle in the front which is viewed from a first vehicle in the back in a case in which the first vehicle is caused to travel following the second vehicle in an embodiment;

FIG. 4 is a diagram illustrating a first vehicle and a second vehicle which are viewed from the side in a case in which the second vehicle is caused to travel following the first vehicle in an embodiment;

FIG. 5 is a diagram chronologically illustrating content of visible light communication and wireless communication performed between a first vehicle and a second vehicle in an embodiment;

FIG. 6 is a flowchart illustrating a control process on a first vehicle side in an embodiment;

FIG. 7 is a flowchart illustrating a control process on a second vehicle side in an embodiment;

FIG. 8 is a diagram illustrating a traveling state of a plurality of vehicles in a case in which an emergency action instruction is transmitted from a first vehicle to a second vehicle in another embodiment;

FIG. 9 is a diagram chronologically illustrating contents of visible light communication and wireless communication performed between a first vehicle and a second vehicle in another embodiment;

FIG. 10 is a diagram illustrating a traveling state of a plurality of vehicles in a case in which an emergency action instruction is transmitted from a first vehicle to a second vehicle in another embodiment;

FIG. 11 is a block diagram illustrating basic configurations of a first vehicle and a second vehicle in a mobile-related communication system according to another embodiment;

FIG. 12 is a diagram chronologically illustrating contents of visible light communication and wireless communication performed between a first vehicle and a second vehicle in another embodiment; and

FIG. 13 is a diagram chronologically illustrating communication between a first vehicle and a second vehicle and signal transfer between components of respective vehicles in a case in which an emergency action instruction is transmitted from the first vehicle to the second vehicle in another embodiment.

### DETAILED DESCRIPTION

Hereinafter, exemplary embodiments of a mobile-related communication system in accordance with the present disclosure will be described in detail with reference to the appended drawings. In the following description, in a case in which a plurality of embodiments, modified examples, or the like are included, it is assumed from the beginning that the characteristic parts thereof are appropriately combined and used. In the following description, similar elements are denoted by the same reference numerals in all the drawings.

### First Embodiment

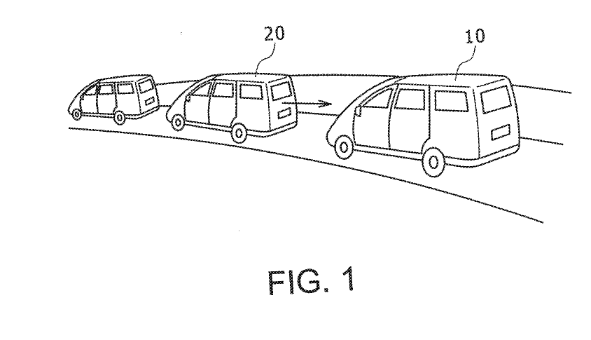

FIG. 1 is a diagram illustrating a traveling state of a first vehicle 10 serving as a first mobile body and a second vehicle 20 serving as a second mobile body to which a first mobile-related communication system according to an embodiment is applied.

FIG. 1 illustrates traveling states of vehicles on an automobile road such as an expressway, and the first vehicle 10 in the back acquires vehicle operation information of the second vehicle 20 in the front, and operation control of the first vehicle 10 is performed. More specifically, the second vehicle 20 is configured to perform automatic driving of traveling following the first vehicle 10 so that a distance from the first vehicle 10 is kept constant. The first vehicle 10 is configured to perform acceleration, deceleration, stop, a turning operation, or the like in accordance with the traveling of the second vehicle 20. To this end, the first vehicle 10 acquires vehicle operation information indicating the traveling state of the second vehicle 20 by means of wireless communication as will be described later. The first vehicle 10 is a first information transmitting body and corresponds to the first mobile body, and the second vehicle 20 is a second information transmitting body and corresponds to the second mobile body. The vehicle operation information of the second vehicle 20 corresponds to transmitting body-related information related to the second vehicle 20.

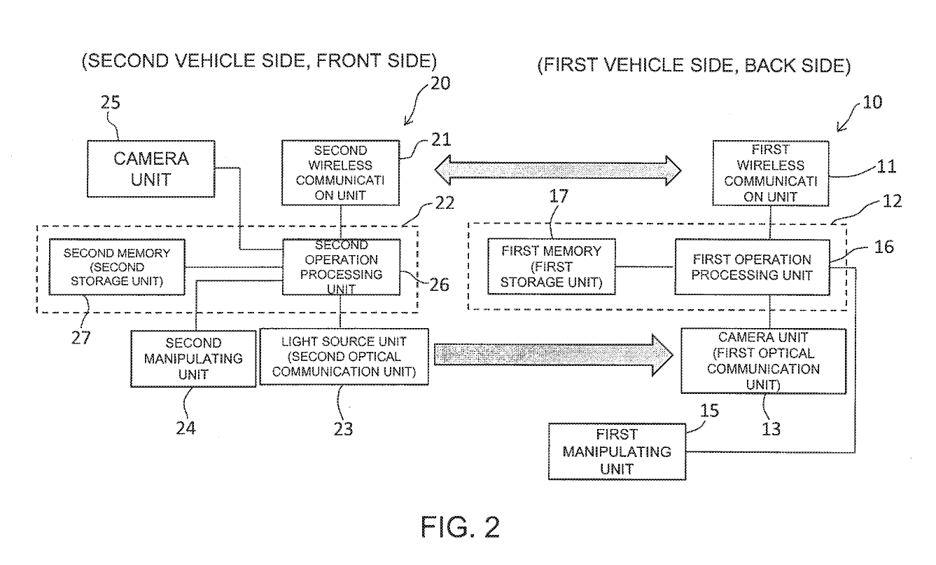

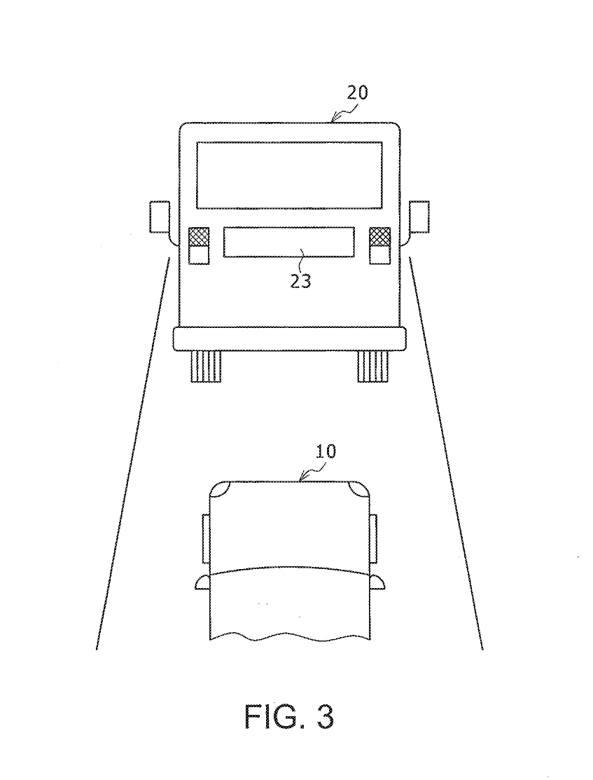

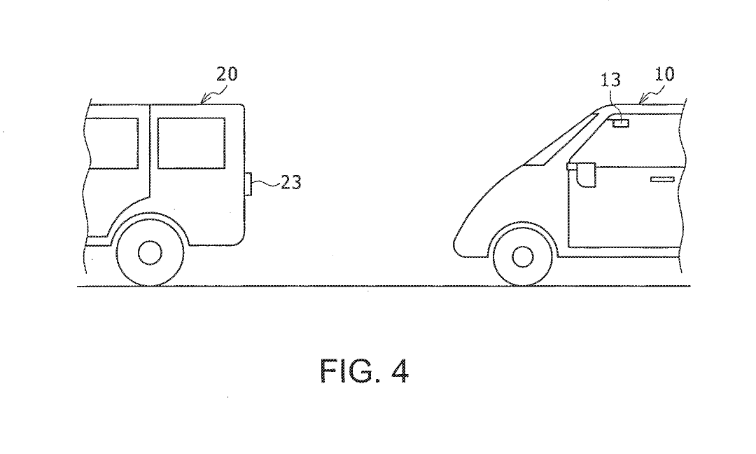

FIG. 2 is a block diagram illustrating basic configurations of the first vehicle 10 and the second vehicle 20. FIG. 3 is a diagram illustrating the second vehicle 20 in the front which is viewed from the first vehicle 10 in the back in a case in which the first vehicle 10 is caused to travel following the second vehicle 20. FIG. 4 is a diagram illustrating the first vehicle 10 and the second vehicle 20 which are viewed from the side in a case in which the second vehicle 20 is caused to travel following the first vehicle 10.

The mobile-related communication system of the embodiment includes the first vehicle 10 and the second vehicle 20 capable of performing wireless communication with the first vehicle 10. As illustrated in FIG. 2, the first vehicle 10 includes a first wireless communication unit 11, a first control unit 12 connected to the first wireless communication unit 11, a camera unit 13 serving as a first optical communication unit connected to a first operation processing unit 16 (to be described later) of the first control unit 12, and a first manipulating unit 15. The first control unit 12 is a controller including the first operation processing unit 16 and a first memory 17 serving as a first storage unit connected to the first operation processing unit 16. The first operation processing unit 16 is a circuit or the like. The first manipulating unit 15 is connected to the first operation processing unit 16 of the first control unit 12. The first wireless communication unit 11 is a circuit or the like performing wireless communication with a second wireless communication unit 21 (to be described later) of the second vehicle 20. Wireless communication is a NFC such as a Bluetooth, RF or the like. As illustrated in FIG. 4, for example, the camera unit 13 is installed toward the front in a front part of the inside of the first vehicle 10; for example, near a front side mirror and images a vehicle, a road, or the like in front of the first vehicle 10. The camera unit 13 includes an imaging element called an image sensor including a plurality of light receiving element units, and an image captured by the camera unit 13 is stored in the first memory 17. The first manipulating unit 15 is a switch, a button, a touch panel, or the like.

The first control unit 12 is suitably constituted by a microcomputer having the first operation processing unit 16, the first memory 17, an I/O interface, and the like. The first control unit 12 reads a program, data, and the like stored in the first memory 17 and executes a predetermined operation. As the program is executed by the first control unit 12, a main function of a device, a system, or a method in the present disclosure is implemented. The first control unit 12 includes a processor (first operation processing unit) operating in accordance with a program as a main hardware configuration. Any type of process can be used, so long as the process can implement the function as a program is executed. The processor is constituted by one or more electronic circuits including a semiconductor integrated circuit (IC) or a large scale integration (LSI) circuit. A plurality of electronic circuits may be integrated into one chip or may be installed in a plurality of chips. A plurality of chips may be integrated into one device or may be installed in a plurality of devices. The first memory 17 is a ROM or the like which is readable by the first operation processing unit 16. Instead of the first memory 17, a non-transitory recording medium such as an optical disk, a hard disk drive, or the like may be used as the first storage unit. The program may be stored in a recording medium in advance or may be supplied to a recording medium via a wide area communication network including the Internet or the like.

The second vehicle 20 includes the second wireless communication unit 21, a second control unit 22 connected to the second wireless communication unit 21, a light source unit 23 serving as a second optical control unit connected to a second operation processing unit 26 of the second control unit 22, a second manipulating unit 24, and a camera unit 25. The second wireless communication unit 21 is a circuit or the like performing wireless communication with the first wireless communication unit 11. The second control unit 22 is a controller including the second operation processing unit 26 and a second memory 27 serving as a second storage unit connected to the second operation processing unit 26. The second operation processing unit 26 is a circuit or the like. The second manipulating unit 24 and the camera unit 25 are connected to the second operation processing unit 26 of the second control unit 22.

As illustrated in FIGS. 3 and 4, the light source unit 23 is arranged toward the back in a rear part of the second vehicle 20, and transmits information by means of visual light communication serving as optical communication. For example, the light source unit 23 is a panel light source and transmits information in accordance with a high-speed change in light intensity. Vehicle ID information IDA serving as identification information of the second vehicle 20 and an encryption key (A key) are emitted from the light source unit 23 as optical communication data. In the present disclosure, the encryption key is also used as a decryption key. The panel light source constantly displays as an optical signal a signal indicating ID information serving as an individual identification signal of the second vehicle 20. At this time, when a panel light source which is elongated in a lateral direction is used, the light emitting unit can be arranged at a plurality of lateral positions, and the individual identification signal of the second vehicle 20 can be displayed two or more times. Accordingly, it is easy for the camera unit 13 of the first vehicle 10 to read the ID information of the second vehicle 20.

ID information specific to a part, for example, the light source unit 23, may be emitted as the ID information of the second vehicle 20. The encryption key is a key serving as code information for decoding in a case in which vehicle operation information encrypted with a wireless signal is received by the first vehicle 10, as will be described later. It is possible to perform optical communication between the light source unit 23 and the camera unit 13 which receives the optical communication data emitted from the light source unit 23. The second manipulating unit 24 is a switch, a button, a touch panel, or the like. The camera unit 25 of the second vehicle 20 is installed toward the front; for example, in the front part of the interior of the second vehicle 20 or near the front side mirror. The function of the camera unit 25 is similar to that of the camera unit 13 of the first vehicle 10. A light source unit similar to that of the second vehicle 20 may be installed in the first vehicle 10.

The second control unit is suitably constituted by a microcomputer including the second operation processing unit 26, the second memory 27, an I/O interface, and the like. The second control unit 22 reads a program, data, the ID information of the second vehicle 20, the vehicle operation information, and the like stored in the second memory 27 and executes a predetermined operation. As the program is executed by the second control unit 22, a main function of a device, a system, or a method in the present disclosure is implemented. The second control unit 22 includes a processor (second operation processing unit) operating in accordance with a program as a main hardware configuration. Any type of process can be used, so long as the process can implement the function as a program is executed. The processor is constituted by one or more electronic circuits including a semiconductor integrated circuit (IC) or a large scale integration (LSI) circuit. A plurality of electronic circuits may be integrated into one chip or may be installed in a plurality of chips. A plurality of chips may be integrated into one device or may be installed in a plurality of devices. The second memory 27 is a ROM or the like which is readable by the second operation processing unit 26. Instead of the second memory 27, a non-transitory recording medium such as an optical disc, a hard disc drive, or the like may be used as a second storage unit. The program may be stored in a recording medium in advance or may be supplied to a recording medium via a wide area communication network including the Internet or the like.

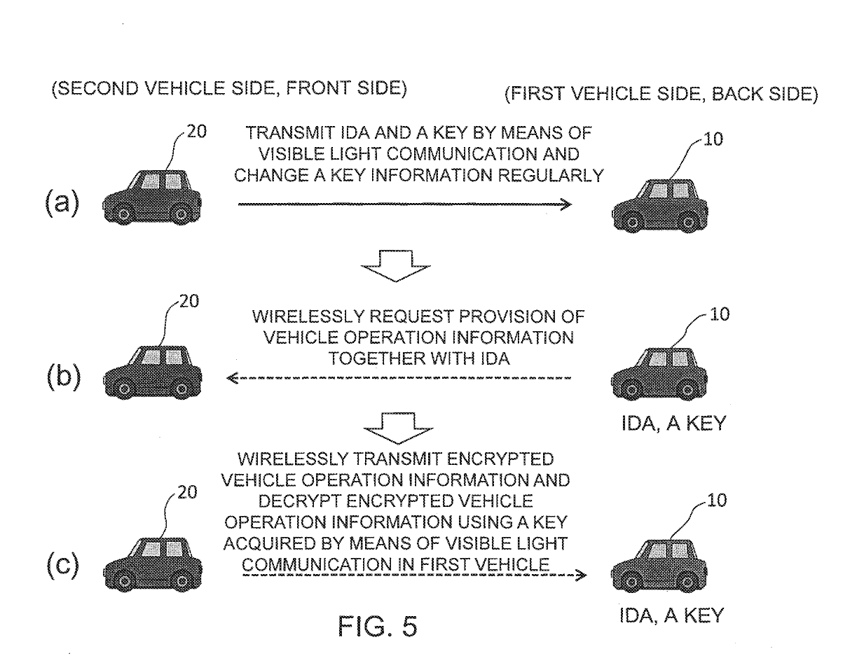

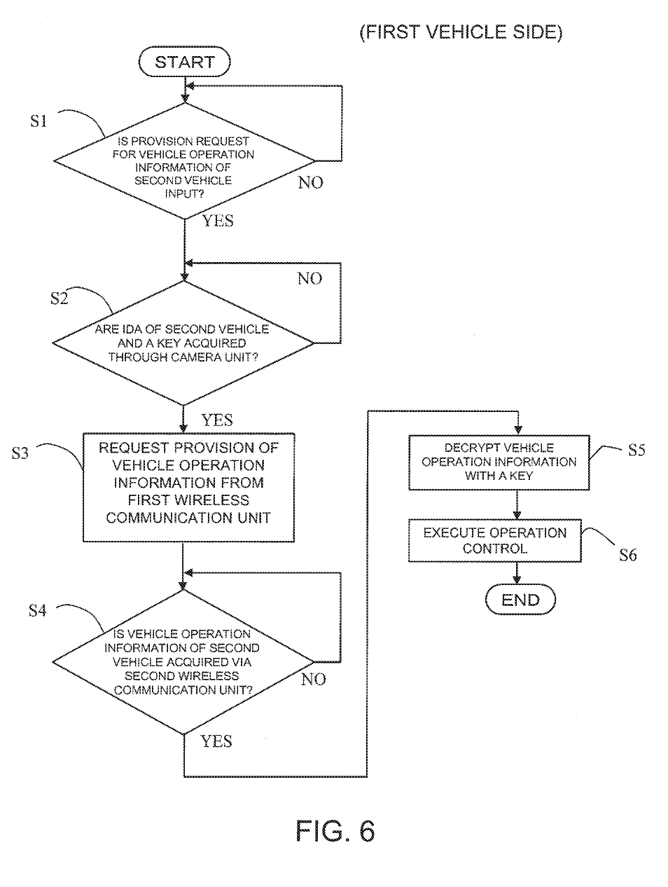

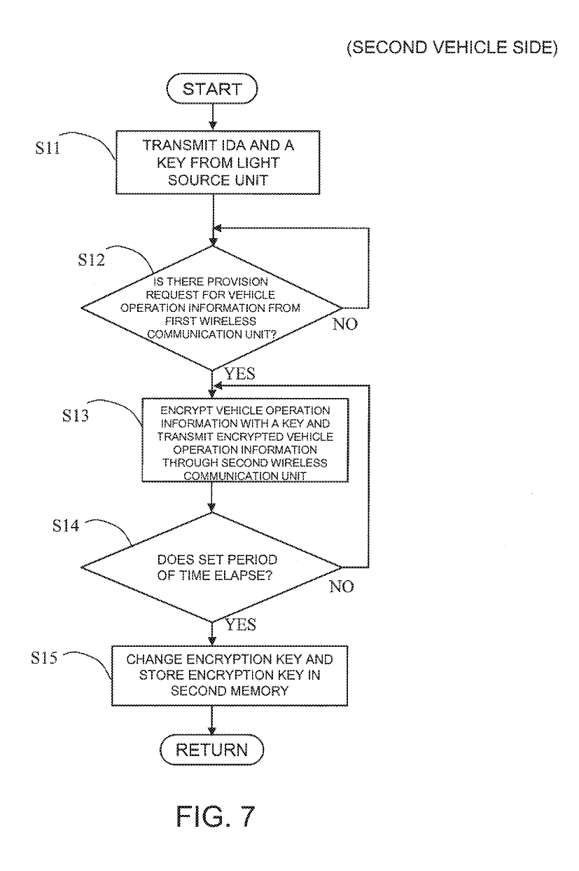

Next, control in a case in which the first vehicle 10 in the back is caused to acquire the vehicle operation information of the second vehicle 20 from the second vehicle 20 traveling in the front will be described with reference to FIGS. 5 to 7. FIG. 5 is a diagram chronologically illustrating content of visible light communication and wireless communication performed between the first vehicle 10 and the second vehicle 20. FIG. 6 is a flowchart illustrating a control process on the first vehicle 10 side. FIG. 7 is a flowchart illustrating a control process on the second vehicle 20 side.

As illustrated in FIG. 5(c), in order for the first vehicle 10 traveling in the back to acquire the vehicle operation information from the second vehicle 20 traveling in the front, first, an input manipulation for requesting provision of the vehicle operation information of the second vehicle 20 is performed through the first manipulating unit 15 of the first vehicle 10. If the input manipulation is performed through the first manipulating unit 15, the following operations (1) to (3) are sequentially performed.

(1) The first control unit 12 of the first vehicle 10 causes the camera unit 13 to acquire the ID information of the second vehicle 20 and the encryption key via the light source unit 23, and causes the first wireless communication unit 11 to wirelessly transmit to the second vehicle 20 a signal for requesting the provision of the vehicle operation information of the second vehicle 20. This state corresponds to FIGS. 5(a) and 5(b).

(2) The second control unit 22 of the second vehicle 20 wirelessly transmits the vehicle operation information encrypted with the encryption key from the second wireless communication unit 21 to the first wireless communication unit 11 on the basis of the vehicle operation information provision request from the first vehicle 10. This state corresponds to FIG. 5(c).

(3) The first control unit 12 decrypts and acquires the encrypted vehicle operation information received by the first wireless communication unit 11 using the encryption key. This state also corresponds to FIG. 5(c).

Thereafter, on the basis of the vehicle operation information, the first control unit 12 controls an operation of a traveling power source such as an engine of the first vehicle 10 or a traveling motor, a brake device, a steering device, or the like. Accordingly, the first control unit 12 controls the first vehicle 10 such that the first vehicle 10 travels following the second vehicle 20 while keeping a constant distance with the second vehicle 20, via a vehicle control unit (ECU) (not illustrated). At this time, the brake device and the steering device are configured to be electrically controllable by an electric motor or the like.

A control process in such an operation will be described in further detail by dividing it into a control process on the first vehicle 10 side of FIG. 6 and a control process on the second vehicle 20 side of FIG. 7. The control process on the first vehicle 10 side will be described with reference to FIG. 6. The control processes illustrated in FIG. 6 and FIG. 7 to be described later is started when the first control unit 12 and the second control unit 22 of the vehicles are powered on and supplied with electric power and repeatedly executed, for example, with a predetermined control cycle.

In step S1 of FIG. 6, the first control unit 12 determines whether or not the provision request for the vehicle operation information of the second vehicle 20 is input. If a positive determination (YES) is made in step S1, the process proceeds to step S2, and if a negative determination (NO) is made, the determination process is repeated.

Then, in step S2, the first control unit 12 determines whether or not the ID information of the second vehicle 20 and the encryption key are acquired via the light source unit 23 by the camera unit 13. If a positive determination (YES) is made in step S2, the process proceeds to step S3, and if a negative determination (NO) is made, the determination process is repeated.

On the other hand, in step S11 of FIG. 7, when it is powered on, the second control unit 22 constantly transmits the ID information IDA of the second vehicle 20 and the encryption key (A key) toward the back from the light source unit 23 as optical information by means of visible light communication. The state at this time corresponds to FIG. 5(a). The encryption key is periodically updated or changed by the second control unit 22 as will be described later. In FIG. 5, a solid line arrow indicates visible light communication, and a broken line arrow indicates wireless communication.

Returning to FIG. 6, in step S3, the first control unit 12 causes the first wireless communication unit 11 to wirelessly transmit to the second vehicle 20 the provision request for the vehicle operation information of the second vehicle 20 together with the ID information of the second vehicle 20 and the encryption key which are already acquired. The state at this time corresponds to FIG. 5(b).

In this case, the second vehicle 20 wirelessly receives the provision request from the first vehicle 10 through the second wireless communication unit 21. Here, when the second control unit 22 determines in step S12 of FIG. 7 that the provision request for the vehicle operation information is received from the first wireless communication unit 11, the process proceeds to step S13. In step S13, the second control unit 22 encrypts the vehicle operation information of the second vehicle 20 stored in the second memory 27 with the encryption key, and causes the second wireless communication unit 21 to transmit the vehicle operation information. Here, the vehicle operation information is information which is sequentially provided from the vehicle control unit (not illustrated) of the second vehicle 20 to the second memory 27 and updated, and includes the speed of the second vehicle 20, the presence or absence of the brake operation, front direction video information obtained by the camera unit 25 of the second vehicle 20, and the like.

Then, returning to FIG. 6, in the first vehicle 10, in a case in which the first control unit 12 determines in step S4 that the vehicle operation information of the second vehicle 20 is acquired via the second wireless communication unit 21, the process proceeds to step S5. In step S5, the first control unit 12 decrypts the encrypted vehicle operation information using the encryption key (A key) of the second vehicle 20 stored in the first memory 17, and in step S6, the first control unit 12 causes the operation control of the first vehicle 10 to be executed on the basis of the vehicle operation information. The operation control is, for example, automatic driving in which the distance from the second vehicle 20 is kept constant and implemented by providing the vehicle operation information of the second vehicle 20 to the vehicle control unit of the first vehicle 10. The state at this time corresponds to FIG. 5(c).

The vehicle control unit of the first vehicle 10 may be configured to cause preparation for the brake operation of the first vehicle 10 to be executed if it is determined that an area in front of the second vehicle 20 is congested, on the basis of the video from the camera unit 25 of the second vehicle 20 as the vehicle operation information of the second vehicle 20.

Returning to FIG. 7, after the second control unit 22 of the second vehicle 20 causes the encrypted vehicle operation information to be transmitted by means of wireless communication in step S13, in a case in which it is determined in step S14 that a predetermined set time elapses, the process proceeds to step S15. In step S15, the second vehicle 20 causes the second control unit 22 to change the encryption key, and the second control unit 22 causes the changed encryption key to be stored in the second memory 27. Accordingly, in the second vehicle 20, the encryption key is changed each time a predetermined time elapses. After step S15, the process returns to step S11, and the process is repeated. As described above, the encryption key transferred from the light source unit 23 backward by means of optical communication is changed at intervals of predetermined times. Therefore, when the predetermined time is set to a sufficiently short time, substantially only the first vehicle 10 located behind the light source unit 23 behind the second vehicle 20 continuously acquires the vehicle operation information of the second vehicle 20 in the front. This is because the first vehicle 10 can acquire the latest encryption key and the vehicle ID transferred by means of optical communication behind the second vehicle 20. Accordingly, it is possible to prevent inadvertent use of the vehicle operation information of the second vehicle 20. Since the vehicle operation information of the second vehicle 20 is transmitted from the second wireless communication unit 21 via the wireless communication, if the encryption key is constantly identical, even a vehicle not located behind the second vehicle 20 can continuously acquire the vehicle operation information if the vehicle acquires the encryption key once, which is undesirable. Therefore, as described above, it is desirable to change the encryption key in a short time. The changed encryption key is stored in the first memory 17 of the first vehicle 10 each time the encryption key is changed. This operation is continued so long as the first control unit 12 of the first vehicle 10 and the second control unit 22 of the second vehicle 20 are in the power ON state, and if the power supply is turned off, the operation ends.

According to the mobile-related communication system of the present embodiment described above, it is possible to suppress the leakage of information to an unrelated third party when wireless communication of information is performed between the first vehicle 10 and the second vehicle 20 which are two information transmitting bodies, while increasing an application range of optical communication.

### Second Embodiment

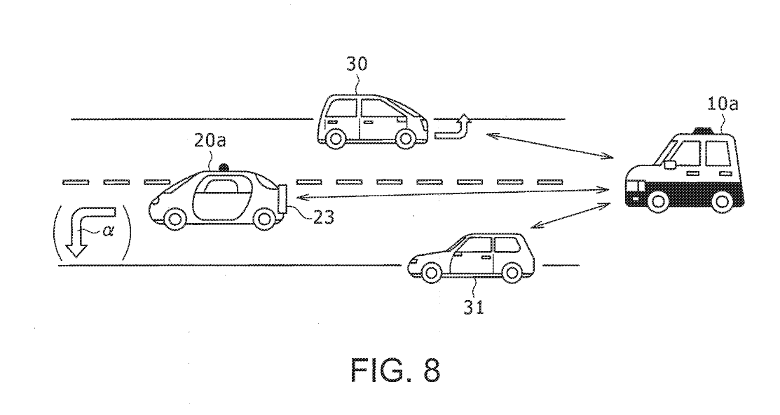

FIG. 8 is a diagram illustrating a traveling state of a plurality of vehicles in a case in which an emergency action instruction is transmitted from a first vehicle 10a to a second vehicle 20a in a second embodiment as another embodiment. In FIG. 8, the first vehicle 10a in the back is an emergency vehicle such as a police vehicle, and a state in which the first vehicle 10a is performing emergency traveling while blowing a siren which is an alarming device is illustrated. In this state, among a plurality of vehicles 20a, 30, and 31 illustrated in FIG. 8, some vehicles 30 and 31 hear the sound of the siren of the first vehicle 10, pull over by their own intention, and help emergency traveling of the first vehicle 10.

On the other hand, the second vehicle 20a is traveling straight in the front without understanding the above-described situation and is not aware of the presence of the first vehicle 10 in the back. In a case in which such a second vehicle 20a is located in the front, the first vehicle 10a acquires the vehicle operation information of the second vehicle 20a, executes operation control on the basis of the vehicle operation information, and automatically avoids the second vehicle 20a. To this end, first, the first vehicle 10a in the back performs an input for requesting the provision of the vehicle operation information of the second vehicle 20a through the first manipulating unit 15. Basic controls of the first vehicle 10a and the second vehicle 20a at this time are similar to the control illustrated in FIGS. 6 and 7. For example, similarly to step S2 of FIG. 6, the first vehicle 10a acquires the ID information of the second vehicle 20a and the encryption key from the second vehicle 20a via the light source unit 23 by the camera unit 13.

At this time, if it is in the power ON state, the second vehicle 20a in the front constantly outputs the ID information of the second vehicle 20a and the encryption key (A key) toward the back as optical information from the light source unit 23.

The first control unit 12 of the first vehicle 10a requests the second vehicle 20a in the front to provide the vehicle operation information through the first wireless communication unit 11 by means of wireless communication, similarly to step S3 of FIG. 6. Further, in the present embodiment, the first vehicle 10a is an emergency vehicle. For this reason, the first vehicle 10a encrypts an emergency vehicle ID of the first vehicle 10a and an emergency vehicle encryption key with the encryption key (A key) of the second vehicle 20a which is already acquired. Then, the first vehicle 10a wirelessly transmits the encrypted emergency vehicle ID and the emergency vehicle encryption key to the second vehicle 20a together with the provision request for the vehicle operation information.

Then, the second vehicle 20a receives the provision request through the second wireless communication unit 21, encrypts the vehicle operation information stored in the second memory 27 with its own encryption key (A key), and wirelessly transmits the encrypted vehicle operation information to the first vehicle 10a through the second wireless communication unit 21. If the vehicle operation information is provided from the second vehicle 20a in the front to the first vehicle 10a via the first and second wireless communication units 11 and 21, the vehicle operation information is decrypted using the encryption key (A key) of the second vehicle 20a stored in the first memory 17. Then, the first vehicle 10a performs an operation control on the basis of the vehicle operation information. At this time, as the operation control, for example, the first vehicle 10a can predict the action of the second vehicle 20a and execute driving of seeking a response to a next action. For example, in FIG. 8, in a case in which the second vehicle 20a puts a sudden brake or performs a sudden steering operation, the first vehicle 10a can respond as early as possible. The second vehicle 20a changes the encryption key at intervals of predetermined times by the second control unit 22 and stores the changed encryption key in the second memory 27. At this time, since the encryption key transferred from the light source unit 23 toward the back by means of optical communication is changed each time a predetermined time elapses, only the second vehicle 20a behind the first vehicle 10a can continuously acquire the vehicle operation information of the second vehicle 20a. The second vehicle 20a acquires the encryption key and the vehicle ID transferred from the light source unit 23 toward the back by means of optical communication behind the first vehicle 10a. Accordingly, it is possible to prevent inadvertent use of the vehicle operation information of the second vehicle 20a. The operation of the first vehicle 10a is continued so long as the first control unit 12 of the first vehicle 10a is in the power ON state, and if the power supply is turned off, the operation ends.

In the present embodiment, the emergency vehicle ID of the first vehicle 10a and the emergency vehicle encryption key which are encrypted with the encryption key (A key) of the second vehicle 20a are wirelessly transmitted from the first vehicle 10a in the back which is the emergency vehicle together with the provision request for the vehicle operation information. The wireless transmission can be received by the vehicle located near the first vehicle 10a so long as the vehicle includes the wireless communication unit, but since it is encrypted with the encryption key (A key) of the second vehicle 20a, only the second vehicle 20a in front of the first vehicle 10a can recognize the encrypted information. For example, the emergency vehicle ID and the emergency vehicle encryption key may be received by a control unit of a vehicle different from the second vehicle 20a by means of wireless communication. Further, thereafter, the different vehicle may receive an emergency action instruction of stopping at the side of the road such as the shoulder and clearing the way by means of wireless communication with the emergency vehicle ID and the emergency vehicle encryption key. In this case, only the second vehicle 20a can decrypt the instruction on the basis of the emergency vehicle ID and the emergency vehicle encryption key and recognize the instruction. At this time, the second vehicle 20a may have a configuration for outputting content of the emergency action instruction (pull over and clear the way) by voice, such as by voice data, as a notification from a speaker (not illustrated) connected to the second control unit 22. Further, the content of the emergency action instruction may be displayed by a display unit (not illustrated) such as a display connected to the second control unit 22 as a notification. In a case in which the driver of the second vehicle 20a receives the notification, the driver of the second vehicle 20a can cancel the automatic driving and stop the vehicle at the side of the road manually. At this time, since the notification of the emergency action instruction is given only to the second vehicle 20a, the first vehicle 10a can smoothly perform the emergency traveling.

In this configuration, if the emergency vehicle encryption key is periodically changed on the first vehicle 10 side, when the second vehicle 20a is no longer located in front of the first vehicle 10a, even the vehicle near the first vehicle 10a is unable to recognize the emergency vehicle ID and the emergency vehicle encryption key information. The present embodiment is different from the first embodiment in that the emergency action instruction from the first vehicle 10a can be transferred to the second vehicle 20a in the front. In the present embodiment, the remaining configurations and operations are similar to those in the first embodiment illustrated in FIGS. 1 to 7.

### Third Embodiment

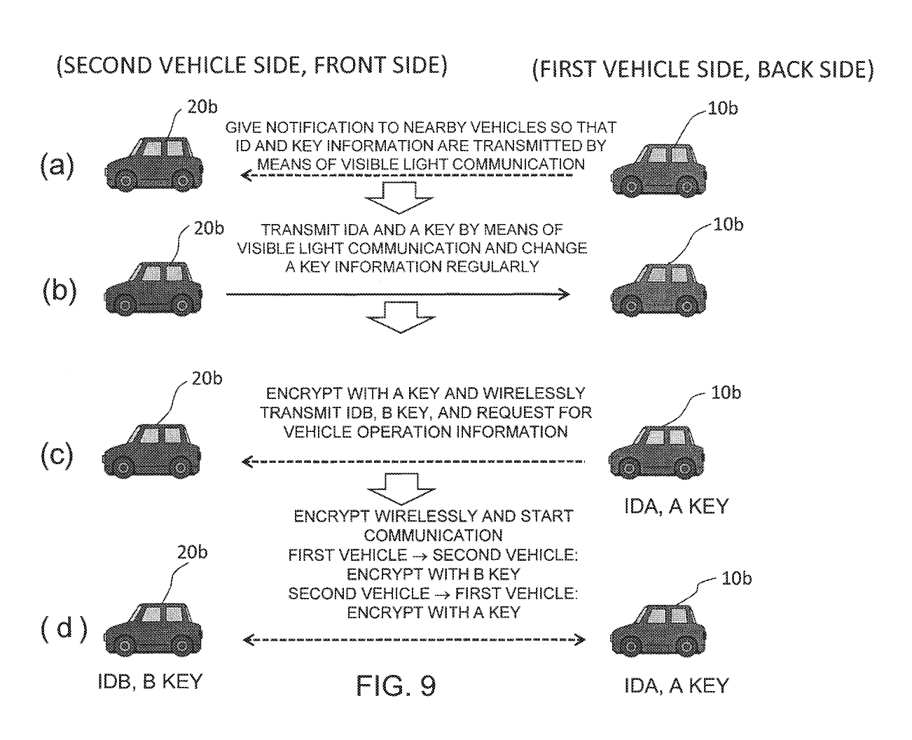

FIG. 9 is a diagram chronologically illustrating contents of visible light communication and wireless communication performed between a first vehicle 10b and a second vehicle 20b in a third example as another embodiment. The first vehicle 10b in the back is an emergency vehicle, similarly to the second embodiment described with reference to FIG. 8. In the second embodiment, the second vehicle 20a in the front constantly emits the ID information of the second vehicle 20a and the encryption key toward the back as the optical information from the light source unit 23 in the power ON state. On the other hand, even in the power ON state, the second vehicle in the front may not constantly emit the ID information of the second vehicle 20 and the encryption key as the optical information from the light source unit. The present embodiment is effective in this case. Specifically, in the present embodiment, in the first vehicle 10b which is an emergency vehicle or the like, an input for requesting the provision of the vehicle operation information of the second vehicle 20b is performed through the first manipulating unit 15 as the emergency action instruction or the like. Accordingly, as illustrated in FIG. 9(a), the first control unit 12 gives a notification using a wireless signal to the vehicle such as the second vehicle 20b located near the first vehicle 10b through the first wireless communication unit 11 so that the ID information IDA and the encryption key (A key) are transmitted by means of the visible light communication. Then, in the second vehicle 20b that has received the wireless signal, the second control unit 22 transmits the ID information IDA of the second vehicle 20b and the encryption key from the light source unit 23 by means of optical communication. This state corresponds to FIG. 9(b).

Thereafter, the first control unit 12 of the first vehicle 10b encrypts the request for providing the vehicle operation information with the already acquired encryption key (A key) of the second vehicle 20b to the second vehicle 20b in the front through the first wireless communication unit 11 by means of wireless communication. At this time, as illustrated in FIG. 9(c), the first vehicle 10b encrypts an emergency vehicle ID (IDB) of the first vehicle 10b and an emergency vehicle encryption key (B key) with the already acquired encryption key (A key) of the second vehicle 20b. Then, the first vehicle 10b wirelessly transmits the encrypted emergency vehicle ID (IDB) and the emergency vehicle encryption key (B key) to the second vehicle 20b together with the provision request for the encrypted vehicle operation information.

Then, the second vehicle 20b receives the provision request through the second wireless communication unit 21, encrypts the vehicle operation information stored in the second memory 27 with its own encryption key (A key), and wirelessly transmits the encrypted vehicle operation information to the first vehicle 10b through the second wireless communication unit 21. The state at this time corresponds to FIG. 9(d). If the encrypted vehicle operation information is received from the second vehicle 20b in the front through the wireless signal, the first vehicle 10b in the back decrypts the vehicle operation information using the encryption key (A key) of the second vehicle 20b stored in the first memory 17. Then, the first vehicle 10b performs the operation control on the basis of the vehicle operation information.

Further, as shown in FIG. 9(d), the first vehicle 10b encrypts information indicating the emergency action instruction instructing indicating “pull over at the side of the road such as the shoulder and clear the way” with its own encryption key (B key) and wirelessly transmits the encrypted information to the second vehicle 20b through the first wireless communication unit 11. If the information of the emergency action instruction is received from the first vehicle 10b in the back through the wireless signal, the front second vehicle 20b decrypts the emergency action instruction information using the encryption key (B key) of the first vehicle 10b stored in the second memory 27. Then, the second vehicle 20b outputs content of the emergency action instruction (please stop at the side of the road and clear the way) by voice, such as by voice data, as a notification from a speaker (not illustrated) connected to the second control unit 22. Further, the content of the emergency action instruction may be displayed by a display unit (not illustrated) such as a display connected to the second control unit 22 as a notification. In a case in which the driver of the second vehicle 20b receives the notification, the driver of the second vehicle 20b can cancel the automatic driving and stop the vehicle at the side of the road manually. At this time, since the notification of the emergency action instruction is given only to the second vehicle 20b, the first vehicle 10b can smoothly perform the emergency traveling. In the present embodiment, the remaining configurations and operations are similar to those in the first and second embodiments.

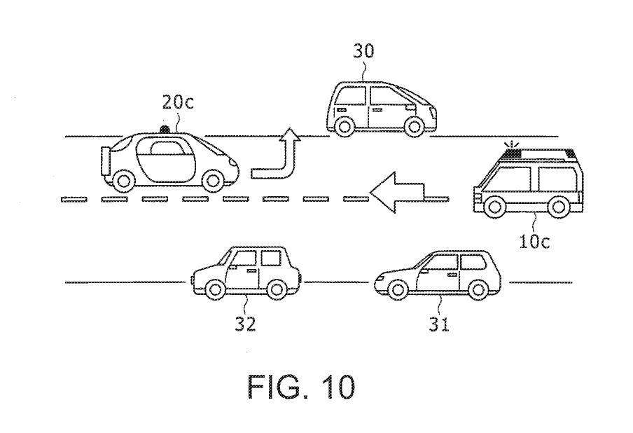

In the third embodiment, similarly to the example illustrated in FIG. 8, the example in which the second vehicle 20b is traveling in the same direction in front of the first vehicle 10b which is an emergency vehicle has been described. On the other hand, FIG. 10 is a diagram illustrating a traveling state of a plurality of vehicles 10c, 20c, 30, 31, and 32 in a case in which the emergency action instruction is transmitted from the first vehicle 10c to the second vehicle 20c in another embodiment. There are cases in which a traveling direction of the first vehicle 10c is opposite to a traveling direction of the second vehicle 20c, and the second vehicle 20c is traveling in front of the first vehicle 10c as illustrated in FIG. 10. FIG. 10 illustrates an example in which the second vehicle 20c is an ambulance which is an emergency vehicle. In this case, the second vehicle 20c includes a light source unit (not illustrated) which is installed on the front side of the vehicle as well as the back side of the vehicle and can receive the ID information IDA and the encryption key (A key) serving as the optical signal emitted by the light source unit on the front side through the camera unit (not illustrated) of the first vehicle 10c. Then, the first vehicle 10c encrypts the ID information IDB of the first vehicle 10c, the encryption key (B key), and the provision request for the vehicle operation information of the second vehicle 20c with the encryption key (A key) of the second vehicle 20c and transmits the encrypted information. The remaining configurations and operations are similar to those in the third embodiment.

In the first to third embodiments, the example in which the information for controlling the vehicle operation is encrypted and communicated between the two vehicles in a front and back position relation as viewed from the first vehicle 10 has been described, but other highly confidential information may be encrypted and communicated. In the second and third embodiments, two-way communication of the encrypted information is performed. In the second and third examples, the example in which the emergency action instruction from the first vehicle 10 serving as an emergency vehicle is communicated to the second vehicle 20 has been described, but highly confidential information may be communicated in addition to the information of the emergency action instruction.

### Fourth Embodiment

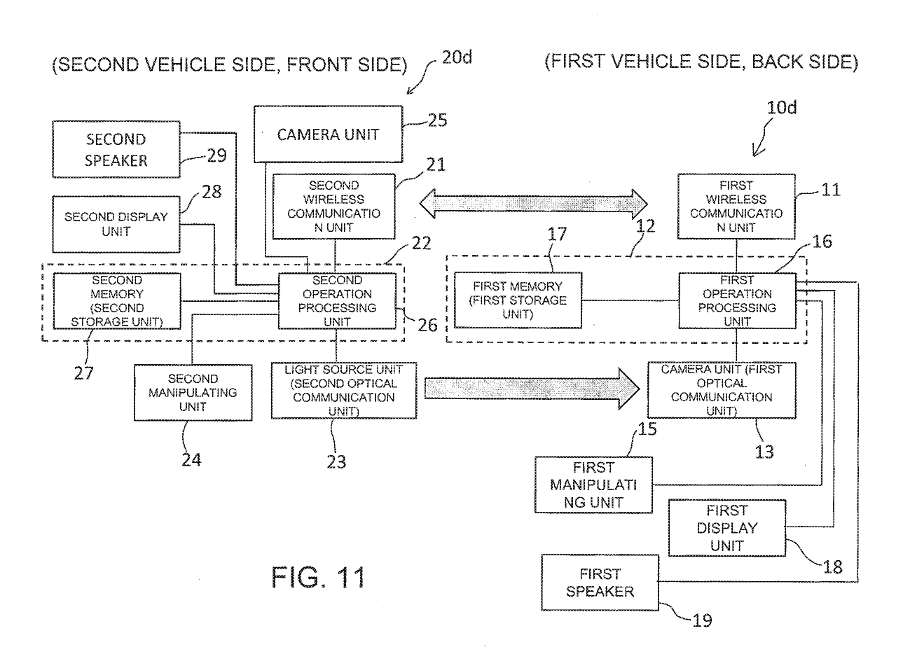

Next, a fourth embodiment will be described with reference to FIGS. 11 to 13. An object of the fourth embodiment is to expand a utilization pattern by performing optical communication between two vehicles on the road and to make it possible to take an emergency action by performing optical communication between the two vehicles on the road.

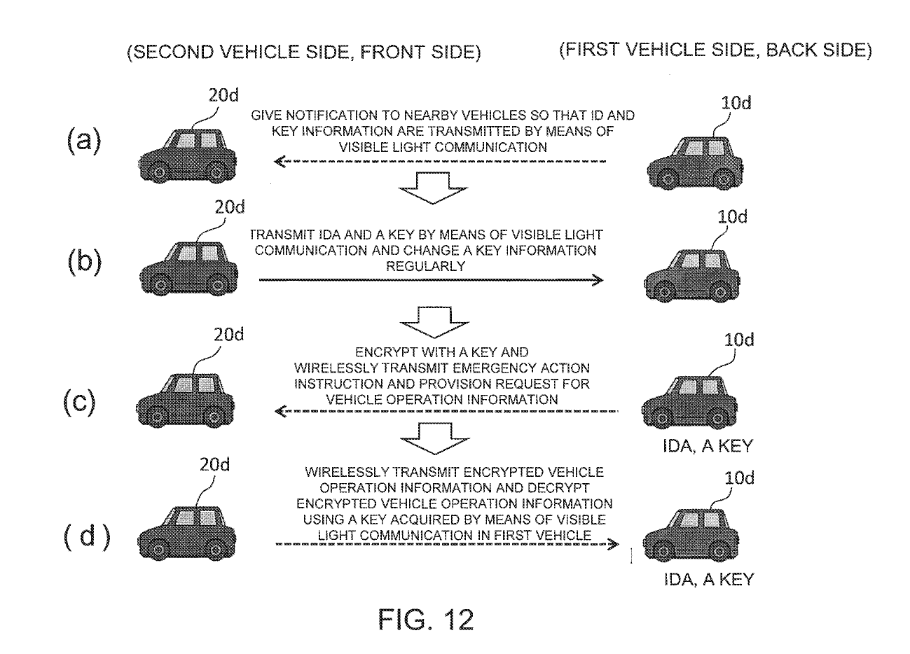

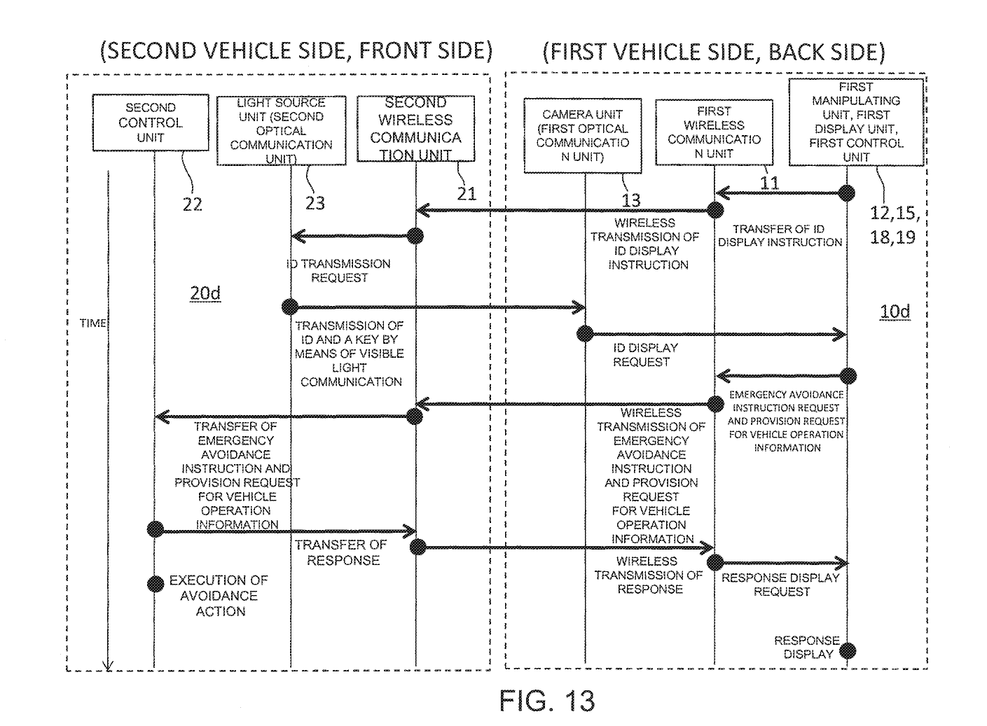

FIG. 11 is a block diagram illustrating basic configurations of a first vehicle 10d and a second vehicle 20d in a mobile-related communication system of a fourth embodiment as another embodiment. FIG. 12 is a diagram chronologically illustrating content of visual light communication and wireless communication performed between the first vehicle 10d and the second vehicle 20d in the fourth embodiment. FIG. 13 is a diagram chronologically illustrating communication between the first vehicle 10d and the second vehicle 20d and signal transfer between components of the respective vehicles 10d and 20d in a case in which the emergency action instruction is transmitted from the first vehicle 10d to the second vehicle 20d in the fourth embodiment.

In FIGS. 11 to 13, the first vehicle 10d and the second vehicle 20d are vehicles capable of performing wireless communication, and the second vehicle 20d is traveling in the same direction in front of the first vehicle 10d. The first vehicle 10d is described as an emergency vehicle (an ambulance, a patrol car, or the like), similarly to the second and third embodiments.

As illustrated in FIG. 11, the first vehicle 10d includes a first wireless communication unit 11, a first control unit 12, a camera unit 13, and a first manipulating unit 15, similarly to the first embodiment illustrated in FIG. 2. Further, the first vehicle 10d includes a first display unit 18 and a first speaker 19 connected to the first control unit 12. The first display unit 18 is, for example, a display arranged on the front side in the vehicle inside. The first speaker 19 is also arranged in the vehicle inside. The first display unit 18 and the first speaker 19 correspond to a first notifying unit. In a case in which the first display unit 18 includes a touch panel, the touch panel also functions as the first manipulating unit.

Similarly to the first embodiment illustrated in FIG. 2, the second vehicle 20d includes a second wireless communication unit 21, a second control unit 22, a camera unit 25, a light source unit 23, and a second manipulating unit 24. Further, the second vehicle 20d includes a second display unit 28 and a second speaker 29 connected to the second control unit 22. The second display unit 28 is, for example, a display arranged on the front side in the vehicle inside. The second speaker 29 is also arranged in the vehicle inside. The second display unit 28 and the second speaker 29 correspond to a second notifying unit. In a case in which the second display unit 28 includes a touch panel, the touch panel also functions as the second manipulating unit.

The light source unit 23 of the second vehicle 20d is arranged in the rear part of the second vehicle 20d, similarly to the configuration illustrated in FIGS. 3 and 4. The light source unit 23 is, for example, a panel light source. The light source unit 23 may constantly display a signal indicating the ID information of the second vehicle 20d as an optical signal, but the second control unit 22 may cause it to be displayed only when there is a request in accordance to a request from the first vehicle 10d, and a light source unit may be installed in the first vehicle 10d, similarly to that of the second vehicle 20d.

A scene setting which is the use state of the configuration illustrated in FIG. 10 is similar as in the configuration illustrated in FIG. 8, and it is assumed that the first vehicle 10d which is an emergency vehicle such as a police vehicle is traveling while blowing a siren. The first vehicle 10d may be an ambulance.

At this time, upon input of an ID display instruction as a first emergency action instruction to the second vehicle 20d through the first manipulating unit 15, the following operations (1) to (6) are sequentially performed.

(1) The first control unit 12 of the first vehicle 10 causes the first wireless communication unit 11 to wirelessly transmit the ID display instruction to the second wireless communication unit 21 of the second vehicle 20d. This state corresponds to FIG. 12(a).

(2) After the ID display instruction is acquired from the first vehicle 10d through the second wireless communication unit 21, the second control unit 22 causes the ID information IDA of the second vehicle 20d and the encryption key (A key) to be transmitted from the light source unit 23 by means of visual light communication serving as optical communication. This state corresponds to FIG. 12(b).

(3) When the first control unit 12 acquires the ID information of the second vehicle 20d and the encryption key via the light source unit 23 through the camera unit 13, the first control unit 12 gives a notification of the second vehicle 20d through the first display unit 18; that is, causes the first display unit 18 to display it.

(4) Thereafter, when a second emergency action instruction to the second vehicle 20d specified by the first manipulating unit 15 which is displayed by the first display unit 18 is given, the first control unit 12 causes the first wireless communication unit 11 to wirelessly transmit the second emergency action instruction to the second vehicle 20d through the first wireless communication unit 11. The second emergency action instruction is “Please stop at the side of the road and clear the way.” At this time, the first control unit 12 causes the first wireless communication unit 11 to wirelessly transmit to the second vehicle 20d the second emergency action instruction and the provision request for the vehicle operation information of the second vehicle 20d serving as the transmitting body-related information. This state corresponds to FIG. 12(c).

(5) When the second control unit 22 receives the second emergency action instruction via the second wireless communication unit 21, the second control unit 22 causes either or both of the second speaker 29 and the second display unit 28 serving as the second uniting units to give a notification indicating that the second emergency action instruction is received. Accordingly, the driver of the second vehicle 20d can recognize the presence of the emergency vehicle therebehind. At the same time, the second control unit 22 causes the encrypted vehicle operation information of the second vehicle 20d to be transmitted from the second wireless communication unit 21 to the first wireless communication unit 11. This state corresponds to FIG. 12(d).

(6) The first control unit 12 decrypts the vehicle operation information received by the first wireless communication unit 11 using the encryption key (A key) and acquires the vehicle operation information. This state also corresponds to FIG. 12(d).

In the operations (1) to (6), similarly to the first embodiment, in a case in which the second vehicle 20d constantly emits the ID information from the light source unit 23, the processes of (1) and (2) may be omitted.

Further, in a case in which the second vehicle 20d is an automatic driving vehicle, when the second emergency action instruction is received via the second wireless communication unit 21, the second control unit 22 may cause the second vehicle 20d to execute an automatic avoidance action as an action corresponding to the second emergency action instruction together with the process of (5). For example, at this time, the second control unit 22 controls the power source such as the engine, the brake device, the steering device, or the like so that the second vehicle 20d pulls over and stops at the shoulder through the vehicle control unit (not illustrated).

Hereinafter, an operation in the present embodiment will be described in further detail. In the first vehicle 10d, if the first manipulating unit 15 is operated, the first control unit 12 wirelessly transfers the ID display instruction serving as the first emergency action instruction to the nearby vehicles including the second vehicle 20d through the first wireless communication unit 11.

After the ID display instruction is received from the first vehicle 10d via the second wireless communication unit 21, the control unit of each vehicle transmits from the light source unit 23 the ID information IDA serving as the identification information specific to each vehicle and the encryption key (A Key) to the vehicle in the back by means of optical communication. Accordingly, the first control unit 12 of the first vehicle 10d can receive a video or an image of the vehicle, the ID information, and the encryption key through the camera unit 13. Then, the ID information which is the reception information is displayed together with the video or the image of the front area in the first display unit 18.

For example, a plurality of vehicles are displayed on the first display unit 18, and for each vehicle the ID information is displayed directly above the vehicle or the like. Accordingly, the occupant of the first vehicle 10d specifies the vehicle only for the second vehicle 20d shown on the first display unit 18 of the first vehicle 10d, and wirelessly transfers the second emergency action instruction (pull over and stop at the shoulder) through the wireless signal via the first wireless communication unit 11. At this time, the occupant of the first vehicle 10d specifies the vehicle to which the second emergency action instruction is transferred through the wireless signal by pushing a part of the touch panel corresponding to the second vehicle 20d shown on the first display unit 18 with a fingertip as the manipulation of the first manipulating unit 15.

At this time, since the second emergency action instruction (pull over and stop at the shoulder) is performed wirelessly, the instruction is also transferred to vehicles other than the second vehicle 20d. On the other hand, in the vehicles other than the second vehicle 20d, the control unit of the vehicle does not cause the emergency action instruction (pull over and stop at the shoulder) to be displayed on each display unit, because the ID information of the vehicle is not included. Further, in the vehicles other than the second vehicle 20d, the notification of the emergency action instruction (pull over and stop at the shoulder) from the speaker is not performed.

On the other hand, the second control unit 22 of the second vehicle 20d causes the emergency action instruction (pull over and stop at the shoulder) to be displayed on the second display unit 28, since the ID information of its own vehicle is included in the received information, and the emergency action instruction (pull over and stop at the shoulder) is output by voice from the second speaker 29. Upon receiving this, if the driver of the second vehicle 20d cancels the automatic operation and manually performs an operation of pulling over and stopping at the shoulder as illustrated by an arrow a in FIG. 8, the second control unit 22 encrypts the execution of the emergency action instruction (pull over and stop at the shoulder) with the encryption key of the second vehicle and transmits it to the first vehicle 10d through the second wireless communication unit 21 as a response. The response information at this time corresponds to the vehicle operation information.

In the first vehicle 10d, the first wireless communication unit 11 receives the execution of the emergency action instruction from the second vehicle 20d (pull over and stop at the shoulder). Accordingly, the first control unit 12 causes the first display unit 18 to perform display indicating that the second vehicle 20d is executing the execution operation of the emergency action instruction (pull over and stop at the shoulder) (for example, understanding, stopping the vehicle, or the like). Further, a notification (for example, understanding, stopping the vehicle, or the like) indicating that the emergency action instruction (pull over and stop at the shoulder) is being executed is given by voice from the first speaker 19.

Further, in the state of FIG. 8, the second vehicle 20d is followed by the first vehicle 10d, and in a case in which the second vehicle 20d does not perform the stopping operation despite issuance of a stop request, it is also possible to forcibly perform an automatic stop by the first control unit 12 and the second control unit 22. In this case, only the second vehicle 20d shown on the first display unit 18 of the first vehicle 10d is specified, and the emergency action instruction (forcibly pull over and stop at the shoulder) is wirelessly transferred via the first wireless communication unit 11. Then, the second vehicle 20d that has received the instruction is forcibly caused to pull over and stop at the shoulder by automatic driving. This is executed through the vehicle control unit of the second vehicle 20d.

According to the above configuration, it is possible to acquire the ID information by means of optical communication between the first vehicle 10d and the second vehicle 20d and give the emergency action instruction from the first vehicle 10d to the second vehicle 20d on the basis of the acquired ID information. In the present embodiment, the remaining configurations and operations are similar to those in the first, second, and third embodiments.

In the fourth embodiment, similarly to the example illustrated in FIG. 8, the example in which the second vehicle 20d is traveling in the same direction in front of the first vehicle 10d which is an emergency vehicle has been described. On the other hand, the configuration of the present embodiment can also be applied to an example in which the second vehicle 20d is traveling in the opposite direction in front of the first vehicle 10d as in the example illustrated in FIG. 10. In this case, the second vehicle 20d includes a light source unit (not illustrated) which is installed on the front side of the vehicle as well as the back side of the vehicle and can receive the ID information IDA and the encryption key (A key) serving as the optical signal emitted by the light source unit on the front side through the camera unit (not illustrated) of the first vehicle 10d. Then, the first vehicle 10d encrypts the emergency action instruction and the request for the vehicle operation information of the second vehicle 20d with the encryption key (A key) of the second vehicle and transmits the encrypted information. The remaining configurations and operations are similar to those in the fourth embodiment.

Further, in each of the above embodiments, as the light source unit of the second vehicle, in addition to the panel light source, another light such as the backlight installed in the second vehicle may also be used. In each of the above embodiments, the first vehicle uses the camera unit as the first optical communication unit, but a component including an imaging element other than the camera may be used. Further, as the mobile body, each of the first vehicle and the second vehicle may be a bicycle, a motorcycle, a train, or the like in addition to an automobile.

The mobile-related communication system of the present disclosure is not limited to a case in which communication is performed between vehicles. For example, the present disclosure can be applied to a configuration in which communication is performed between a vehicle and a fixed body such as a traffic signal, a signboard, or the like. At this time, one of the vehicle and the fixed body functions as the first information transmitting body, and the other functions as the second information transmitting body. For example, the vehicle is assumed to be a first information transmitting body, and a traffic signal including a camera unit at a higher position is assumed to be a second information transmitting body. At this time, the vehicle approaching the traffic signal carries out optical communication and wireless communication with the traffic signal. The traffic signal encrypts image information of an object approaching in the lateral direction which is unable to be seen because of a blind spot of the vehicle such as an intersection and wirelessly transmits the information, and the vehicle can decrypt the information with an encryption key acquired by means of optical communication with the traffic light and cause the image to be displayed on the display unit. Accordingly, safer predictive driving can be performed.

### <Storage of ID Information>

(1) The ID information of the vehicle may be stored in the control unit (not illustrated) of each light source unit, or

(2) The ID information of the vehicle may be read out to the control unit of the light source unit from the control unit (memory unit) of the vehicle. For example, in the case of (1), an installation position of each light source unit in the vehicle of (for example, the right side in the back) and the ID information stored in the control unit of the light source unit may be stored in the control unit (memory unit). Accordingly, for example, even in a case in which the light source unit is replaced with a new light source unit due to the damage of the light source unit at the time of an accident, the original information may be rewritten with the information, or the ID information of the new light source unit may be stored. Further, in a case in which the ID information of the vehicle transmitted by each light source unit is desired to be fixed, the ID information may be read out from the control unit (memory unit) of the vehicle to the control unit of the light source unit each time as in the case of (2).

Further, the mobile-related communication system of the present disclosure can be applied to a configuration in which communication is performed between the vehicle and a toll payment machine serving as a fixed body in a toll road such as an express way. At this time, the vehicle including the light source unit in the front part functions as the second information transmitting body, and the toll payment machine including the camera unit functions as the first information transmitting body. In this case, optical communication and wireless communication are performed between the vehicle approaching the toll payment machine and the toll payment machine. The vehicle encrypts payment information such as a bank account number and wirelessly transmits the encrypted information as transmitting body-related information related to the vehicle, and the toll payment machine can decrypt the information with an encryption key acquired by means of optical communication with the vehicle and use the payment information for a process of paying a toll fee required for traveling.

In the fourth embodiment, upon input of the first emergency action instruction to the second vehicle 20d through the first manipulating unit 15, the first control unit 12 acquires the ID information of the second vehicle 20d and the encryption key via the second optical communication unit by the first optical communication unit. On the other hand, the acquisition of the encryption key may be omitted at this time. For example, at this time, the following operations (1) to (3) are sequentially performed. (1) When the ID information of the second vehicle 20d is acquired via the second optical communication unit by the first optical communication unit, the first control unit 12 causes the first notifying unit to give a notification to the second vehicle 20d. (2) When the second emergency action instruction is input to the second vehicle 20d which has received the notification from the first notifying unit through the first manipulating unit 15, the first control unit 12 causes the first wireless communication unit 11 to wirelessly transmit the second emergency action instruction to the second vehicle 20d. (3) When the second emergency action instruction is received via the second wireless communication unit 21, the second control unit 22 gives a notification indicating that the second emergency action instruction is received through the second notification unit.

The second control unit 22 may be configured to execute an operation of forcibly pulling over at the shoulder in a case in which the second vehicle 20d is an automatic driving vehicle in addition to the operation (3).

Further, when the first emergency action instruction is input to the second vehicle 20d through the first manipulating unit 15, the following operations (A) and (B) may be performed in order before the operation (1). (A) The first control unit 12 wirelessly transmits the first emergency action instruction to the second vehicle 20d via the first wireless communication unit 11. (B) After the first emergency action instruction is received from the first vehicle 10d via the second wireless communication unit 21, the second control unit 22 causes the second optical communication unit to transmit the ID information of the second vehicle 20d by means of optical communication.

With this configuration, similarly to the fourth embodiment, it is possible to acquire the ID information by means of optical communication between the first vehicle 10d and the second vehicle 20d and give the emergency action instruction from the first vehicle 10d to the second vehicle 20d on the basis of the acquired ID information.

The first information transmitting body of at least one of the above-described configurations is the first information transmitting body for use in the mobile-related communication system also including the second information transmitting body that is able to perform wireless communication with the first information transmitting body, wherein the first information transmitting body is the movable body and comprises:

the first wireless communication unit, the first control unit connected to the first wireless communication unit, and the first optical communication unit connected to the first control unit,

wherein

(1) the first control unit causes the first optical communication unit to acquire ID information of the second information transmitting body and the encryption key via the second optical communication unit included in the second information transmitting body and causes the first wireless communication unit to wirelessly transmit to the second information transmitting body a provision request for transmitting body-related information related to the second information transmitting body,

and

(2) the first control unit decrypts the transmitting body-related information received by the first wireless communication unit using the encryption key and acquires the transmitting body-related information.

The second information transmitting body of at least one of the above-described configurations is the second information transmitting body for using in a mobile-related communication system also including the first information transmitting body that is able to perform wireless communication with the second information transmitting body, wherein the second information transmitting body is the movable body and comprises:

the second wireless communication unit that performs wireless communication with the first wireless communication unit included in the first information transmitting body, the second control unit connected to the second wireless communication unit, and the second optical communication unit that is connected to the second control unit and performs optical communication with the first optical communication unit included in the first information transmitting body,

wherein

(1) the second optical communication unit transmits ID information of the second information transmitting body and the encryption key to the first optical communication unit and the second wireless communication unit receives the provision request for transmitting body-related information related to the second information transmitting body from the first wireless communication unit, and

(2) the second control unit causes the transmitting body-related information related to the second information transmitting body and encrypted with the encryption key to be wirelessly transmitted from the second wireless communication unit to the first wireless communication unit on the basis of the provision request for the transmitting body-related information.

A single information transmitting body may include the aspects of both the first and second information transmitting bodies so as to function as one or the other depending on the surrounding environment.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims claim any and all modifications and variations that fall within the true scope of the present teachings.

What is claimed is:

1. A mobile-related communication system comprising:
a first information transmitting body; and
a second information transmitting body that performs wireless communication with the first information transmitting body,
wherein at least one of the first information transmitting body and the second information transmitting body is a mobile body,
the first information transmitting body includes a first wireless communication unit, a first control unit connected to the first wireless communication unit, and a first optical communication unit connected to the first control unit,
the second information transmitting body includes a second wireless communication unit that performs wireless communication with the first wireless communication unit, a second control unit connected to the second wireless communication unit, and a second optical communication unit that is connected to the second control unit and performs optical communication with the first optical communication unit,
(1) the first control unit causes the first optical communication unit to acquire ID information of the second information transmitting body and an encryption key via the second optical communication unit and causes the first wireless communication unit to wirelessly transmit to the second information transmitting body a provision request for transmitting body-related information related to the second information transmitting body,
(2) the second control unit causes the transmitting body-related information encrypted with the encryption key to be wirelessly transmitted from the second wireless communication unit to the first wireless communication unit on the basis of the provision request for the transmitting body-related information, and
(3) the first control unit decrypts the transmitting body-related information received by the first wireless communication unit using the encryption key and acquires the transmitting body-related information.

2. The mobile-related communication system according to claim 1, wherein the first information transmitting body includes a first manipulating unit connected to the first control unit, and when an input manipulation for requesting provision of the transmitting body-related information is performed through the first manipulating unit, the first control unit causes the first optical communication unit to acquire the ID information of the second information transmitting body and the encryption key and causes the first wireless communication unit to wirelessly transmit to the second information transmitting body the provision request for the transmitting body-related information.

3. The mobile-related communication system according to claim 1, wherein the first optical communication unit and the second optical communication unit include a light source unit and a light receiving element unit.

4. The mobile-related communication system according to claim 1, wherein the second control unit regularly changes the encryption key.

5. The mobile-related communication system according to claim 4, wherein the second control unit includes a second storage unit, and the second control unit causes the changed encryption key to be stored in the second storage unit.

6. The mobile-related communication system according to claim 4, wherein the first control unit includes a first storage unit, and the first control unit causes the encryption key acquired by the first optical communication unit to be stored in the first storage unit.

7. The mobile-related communication system according to claim 1, wherein the first information transmitting body is a first mobile body, and the first control unit performs operation control of the first mobile body using the acquired transmitting body-related information.

8. The mobile-related communication system according to claim 1, wherein the second information transmitting body is a second mobile body, and the first control unit causes the first wireless communication unit to transfer an operation request for the second mobile body using the acquired transmitting body-related information.

9. The mobile-related communication system according to claim 1, wherein the first information transmitting body is a first mobile body, the second information transmitting body is a second mobile body, the first mobile body includes a first manipulating unit and a first notifying unit connected to the first control unit, the second mobile body includes a second notifying unit connected to the second control unit, and
upon input of a first emergency action instruction to the second mobile body through the first manipulating unit,
(1) when the first control unit acquires the ID information of the second mobile body and the encryption key via the second optical communication unit by the first optical communication unit, the first control unit causes the first notifying unit to give a notification of the second mobile body,
(2) when a second emergency action instruction to the second mobile body which has received the notification from the first notifying unit is performed through the first manipulating unit, the first control unit causes the first wireless communication unit to wireless transmit the provision request for the transmitting body-related information and the second emergency action instruction to the second mobile body,
(3) when the second control unit receives the second emergency action instruction via the second wireless communication unit, the second control unit gives a notification indicating that the second emergency action instruction is received through the second notifying unit and causes the encrypted transmitting body-related information to be transmitted from the second wireless communication unit to the first wireless communication unit, and
(4) the first control unit decrypts the transmitting body-related information received by the first wireless communication unit using the encryption key and acquires the transmitting body-related information.

10. The mobile-related communication system according to claim 9, wherein, upon input of the first emergency action instruction to the second mobile body through the first manipulating unit, before the first control unit causes the first optical communication unit to acquire the ID information of the second mobile body and the encryption key,
(1) the first control unit causes the first wireless communication unit to wirelessly transmit the first emergency action instruction to the second mobile body, and
(2) after the second control unit receives the first emergency action instruction from the first mobile body via the second wireless communication unit, the second control unit causes the second optical communication unit to transmit the ID information of the second mobile body and the encryption key by means of optical communication.

11. The mobile-related communication system according to claim 9, wherein, when the second control unit receives the second emergency action instruction via the second wireless communication unit, the second control unit causes the second notifying unit to give a notification indicating that the second emergency action instruction is received, and causes the second mobile body to execute an operation corresponding to the second emergency action instruction.

12. The mobile-related communication system according to claim 9, wherein the second mobile body includes a panel light source or a light as the second optical communication unit.

13. The mobile-related communication system according to claim 9, wherein the second mobile body includes a second display unit or a speaker as the second notifying unit.

14. The mobile-related communication system according to claim 9, wherein the first mobile body includes an imaging element as the first optical communication unit.

15. The mobile-related communication system according to claim 9, wherein the first mobile body includes a first display unit as the first notifying unit.

16. The mobile-related communication system according to claim 9, wherein the first mobile body includes an imaging element as the first optical communication unit, includes a first display unit as the first notifying unit, and causes a video or an image captured by the imaging element and the ID information of the second mobile body to be displayed on the first display unit.

17. A first information transmitting body for use in a mobile-related communication system also including a second information transmitting body that is able to perform wireless communication with the first information transmitting body, wherein the first information transmitting body is a movable body and comprises:
a first wireless communication unit, a first control unit connected to the first wireless communication unit, and a first optical communication unit connected to the first control unit,
wherein
(1) the first control unit causes the first optical communication unit to acquire ID information of the second information transmitting body and an encryption key via a second optical communication unit included in the second information transmitting body and causes the first wireless communication unit to wirelessly transmit to the second information transmitting body a provision request for transmitting body-related information related to the second information transmitting body,
and
(2) the first control unit decrypts the transmitting body-related information received by the first wireless communication unit using the encryption key and acquires the transmitting body-related information.

18. A second information transmitting body for using in a mobile-related communication system also including a first information transmitting body that is able to perform wireless communication with the second information transmitting body, wherein the second information transmitting body is a movable body and comprises:
a second wireless communication unit that performs wireless communication with a first wireless communication unit included in the first information transmitting body, a second control unit connected to the second wireless communication unit, and a second optical communication unit that is connected to the second control unit and performs optical communication with a first optical communication unit included in the first information transmitting body,
wherein
(1) the second optical communication unit transmits ID information of the second information transmitting body and an encryption key to the first optical communication unit and the second wireless communication unit receives a provision request for transmitting body-related information related to the second information transmitting body from the first wireless communication unit, and
(2) the second control unit causes the transmitting body-related information related to the second information transmitting body and encrypted with the encryption key to be wirelessly transmitted from the second wireless communication unit to the first wireless communication unit on the basis of the provision request for the transmitting body-related information.
